(19) United States
(12) Patent Application Publication
(10) Pub. No.: US 2003/0093162 A1
(43) Pub. Date: May 15, 2003

(54) Classifiers using eigen networks for recognition and classification of objects

(75) Inventors: Srinivas Gutta, Yorktown Heights, NY (US); Vasanth Philomin, Briarcliff Manor, NY (US); Miroslav Trajkovic, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/014,199

(22) Filed: Nov. 13, 2001

(51) Int. Cl. G06E 1/00; G06E 3/00; G06G 7/00; G06F 15/18; G05B 13/02

(52) U.S. Cl. 700/52; 700/53; 700/48; 700/50

(57) ABSTRACT

Generally, an Eigen network and system using same are disclosed that use Principal Component Analysis (PCA) in a middle (or “hidden”) layer of a neural network. The PCA essentially takes the place of a Radial Basis Function hidden layer. A classifier comprises inputs that are routed to a PCA device. The PCA device performs PCA on the inputs and produces outputs (entitled “PCA outputs” for clarity). The PCA outputs are connected to output nodes. Generally, each output is connected to each output node. Each connection is multiplied by a weight, and each output node uses weighted PCA outputs to produce an output (entitled a “node output” for clarity). These node outputs are then generally compared in order to assign a class to the input. A system uses the PCA classifier to classify input patterns. In a third aspect of the invention, a PCA classifier is trained in order to determine weights for each of the connections that are connected to the output nodes.

### FIELD OF THE INVENTION

The present invention relates to classifiers using neural networks, and more particularly, to classifiers using Eigen networks, that employ Principal Component Analysis (PCA) to determine eigenvalues and eigenvectors, for recognition and classification of objects.

### BACKGROUND OF THE INVENTION

Neural networks attempt to mimic the neural pathways of the human brain. Neural networks are able to “learn” by adjusting certain weights while data processing is being performed by the neural networks. These weights can be (i) adjusted during a learning phase of a neural network, (ii) constantly adjusted, or (iii) adjusted periodically.

There are various configurations for neural networks. Some neural networks are “feed forward” neural networks, in which there are no feedback loops, and other neural networks are “feedback” neural networks (also called “back propagation” neural networks), in which there are feedback loops.

Neural networks have been used for many diverse purposes. One particular use for neural networks is pattern recognition and classification, in which a neural network is used to examine data from an input image in order to determine patterns in the data. The patterns can be placed into known classes. Benefits of using neural networks in these situations are the ability to learn new patterns and the ease at which the neural networks learn base patterns.

Detriments to many neural networks are large storage requirements and lengthy and complex calculations. A need therefore exists for neural networks that reduce storage requirements and calculation complexity, yet provide adequate pattern recognition.

### SUMMARY OF THE INVENTION

Generally, an Eigen network and a system for using the same are disclosed that use Principal Component Analysis (PCA) in a middle (or “hidden”) layer of a neural network. The PCA essentially takes the place of a Radial Basis Function hidden layer.

In one aspect of the invention, a classifier comprises inputs that are routed to a PCA device. The PCA device performs PCA on the inputs and produces outputs (entitled “PCA outputs” for clarity). The PCA outputs are connected to output nodes. Generally, each PCA output is connected to each output node. Each connection is multiplied by a weight, and each output node uses the weighted PCA outputs to produce an output (entitled a “node output” for clarity). These node outputs are then generally compared in order to assign a class to the input.

In a second aspect of the invention, a system uses the PCA classifier to classify input patterns. In a third aspect of the invention, a PCA classifier is trained in order to determine weights for each of the connections that are connected to the output nodes.

Advantages of the present invention include reduced storage space and reduced complexity and length of computations, as compared with, for instance, Radial Basis Function (RBF) classifiers. Additionally, PCA techniques tend to filter out noise in images, which tends to enhance recognition.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary prior art classifier that uses Radial Basis Functions (RBFs);

FIG. 2 illustrates an exemplary classifier that uses Principal Component Analysis (PCA) in accordance with a preferred embodiment of the invention;

FIG. 3 is an illustrative pattern classification system using the classifier of FIG. 2, in accordance with a preferred embodiment of the invention;

FIG. 4 is a flow chart describing an exemplary method for training the system and classifier of FIG. 3; and

FIG. 5 is a flow chart describing an exemplary method for using the system and classifier of FIG. 3 for pattern recognition and classification.

### DETAILED DESCRIPTION

The present invention discloses neural networks that use Principal Component Analysis (PCA). In order to best present the various embodiments of the present invention, it is helpful 2: to first review some basic neural network concepts.

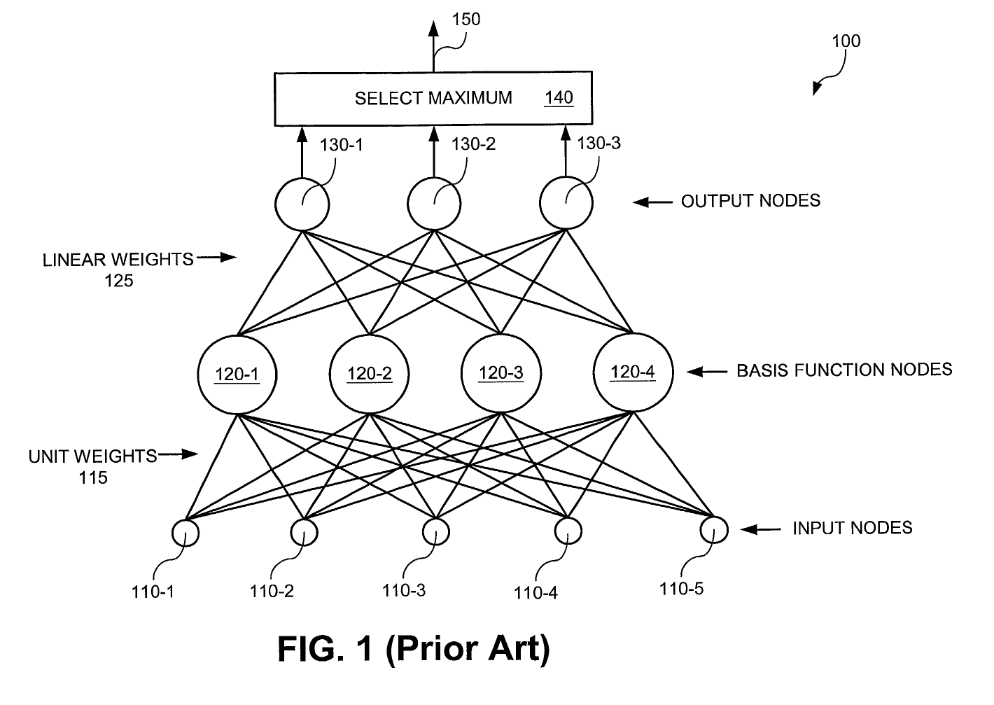

FIG. 1 illustrates an exemplary prior art classifier 100 that uses Radial Basis Functions (RBFs). As described in more detail below, construction of an RBF neural network used for classification involves three different layers. An input layer is made up of source nodes, called input nodes herein. The second layer is a hidden layer whose function is to cluster the data and, generally, to reduce its dimensionality to a limited degree. The output layer supplies the response of the network to the activation patterns applied to the input layer. The transformation from the input space to the hidden-unit space is non-linear, whereas the transformation from the hidden-unit space to the output space is linear.

Consequently, the prior art classifier 100 basically comprises three layers: (1) an input layer comprising input nodes 110 and unit weights 115, which connect the input nodes 110 to Basis Function (BF) nodes 120; (2) a “hidden layer” comprising basis function nodes 120; and (3) an output layer comprising linear weights 125 and output nodes 130. For pattern recognition and classification, a select maximum device 140 and a final output 150 are added.

Note that unit weights 115 are such that each connection from an input node 110 to a BF node 120 essentially remains the same (i.e., each connection is “multiplied” by a one). However, linear weights 125 are such that each connection between a BF node 120 and an output node 130 is multiplied by a weight. The weight is determined and adjusted as described below.

In the example of FIG. 1, there are five input nodes 110, four BF nodes 120, and three output nodes 130. However, FIG. 1 is merely exemplary and, in the description given below, there are D input nodes 110, F BF nodes 120, and M output nodes 130. Each BF node 120 has a Gaussian pulse nonlinearity 2 specified by a particular mean vector μ₁ and variance vector σᵢ², where i=1, . . . ,F and F is the number of BF nodes 120. Note that σᵢ² represents the diagonal entries of the covariance matrix of Gaussian pulse i. Given a D-dimensional input vector X, each BF node i outputs a scalar value yᵢ, reflecting the activation of the BF caused by that input, as follows:

$${y}_{i} = {ϕ}_{i} ( ‖ X - {μ}_{i} ‖ ) = exp [ - {\sum }_{k = 1 }^{D } \frac{{( {x}_{k} - {μ}_{ik} )}^{2}}{2 h {σ}_{ik}^{2}} ] , \qquad [ 1 ]$$

where h is a proportionality constant for the variance, Xₖ is the kth component of the input vector X=[x₁, x₂, . . . , X_{D}], and μᵢₖ and Φᵢₖ are the kth components of the mean and variance vectors, respectively, of basis node i. Inputs that are close to the center of a Gaussian BF result in higher activations, while those that are far away result in lower activations. Since each output node of the RBF classifier 100 forms a linear combination of the BF node 120 activations, the part of the network 100 connecting the middle and output layers is linear, as shown by the following:

$${z}_{j} = {\sum }_{i} {w}_{ij} {y}_{i} + {w}_{oj} , \qquad [ 2 ]$$

where zⱼ is the output of the jth output node, yᵢ is the activation of the ith BF node, wᵢⱼ is the weight connecting the ith BF node to the jth output node, and wₒⱼ is the bias or threshold of the jth output node. This bias comes from the weights associated with a BF node 120 that has a constant unit output regardless of the input.

An unknown vector X is classified as belonging to the class associated with the output node j with the largest output zⱼ, as selected by the select maximum device 140. The select maximum device 140 compares each of the outputs from the M output nodes to determine final output 150. The final output 150 is an indication of the class that has been selected as the class to which the input vector X corresponds. The linear weights 125, which help to associate a class for the input vector X, are learned during training. The weights wᵢⱼ in the linear portion of the classifier 100 are generally not solved using iterative minimization methods such as gradient descent. Instead, they are usually determined quickly and exactly using a matrix pseudoinverse technique. This technique and additional information about RBF classifiers are described in R. P. Lippmann and K. A. Ng, “Comparative Study of the Practical Characteristic of Neural Networks and Pattern Classifiers,” MIT Technical Report 894, Lincoln Labs.,1991, the disclosure of which is incorporated by reference herein.

Detailed algorithmic descriptions of training and using RBF classifiers are well known in the art. Here, a simple algorithmic description of training and using an RBF classifier will now be described. Initially the size of the RBF network is determined by selecting F, the number of BFs. The appropriate value of F is problem-specific and usually depends on the dimensionality of the problem and the complexity of the decision regions to be formed. In general, F can be determined empirically by trying a variety of Fs, or it can set to some constant number, usually larger than the input dimension of the problem.

After F is set, the mean mᵢ and variance σᵢ ² vectors of the BFs can be determined using a variety of methods. They can be trained, along with the output weights, using a back-propagation gradient descent technique, but this usually requires a long training time and may lead to suboptimal local minima. Alternatively, the means and variances can be determined before training the output weights. Training of the networks would then involve only determining the weights.

The BF centers and variances are normally chosen so as to cover the space of interest. Different techniques have been suggested. One such technique uses a grid of equally spaced BFs that sample the input space. Another technique uses a clustering algorithm such as K-means to determine the set of BF centers, and others have chosen random vectors from the training set as BF centers, making sure that each class is represented.

There are several problems associated with the classifier 100 of FIG. 1. First, calculations for each BF node 120 are lengthy and time-consuming. Second, there is a small or no dimensionality decrease caused by the BF nodes 120. What this means is that the input vector X has D dimensions. Each BF node 120 produces a scalar, but there are generally quite a few BF nodes 120 relative to the number of input nodes, D. Generally, the number, F, of BF nodes 120 is about or greater than D. For instance, with an image of size 256 pixels by 256 pixels, an input vector has 65,536 points (256×256). Thus, X could have 65,536 dimensions, and even a major reduction in the number, F, of BF nodes 120 will still provide a large dimensionality in terms of outputs from BF nodes 120. Consequently, the reduction in dimensionality from the D dimensions of the input vector X to the F outputs of the BF nodes 120 is relatively small.

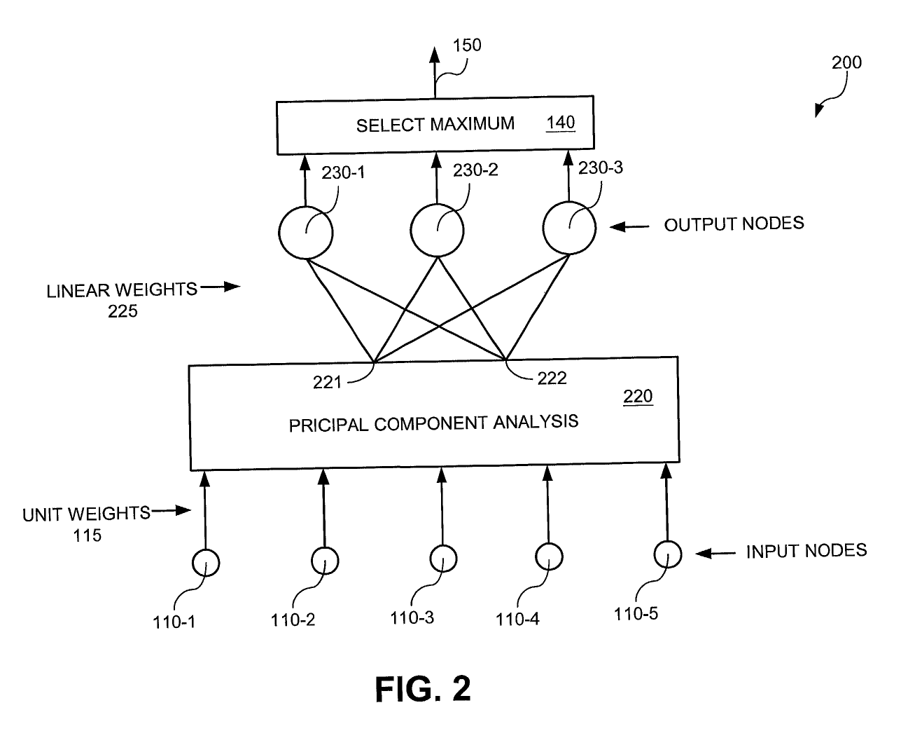

FIG. 2 illustrates an exemplary classifier 200 that uses Principal Component Analysis (PCA) in accordance with a preferred embodiment of the invention. The classifier 200 reduces the dimensionality of the output of the hidden layer by using PCA in the hidden layer to determine the outputs. This reduction in dimensionality is relative to a hidden layer that uses RBFs. This reduction in dimensionality means that less storage space is required, as compared to a classifier using RBFs. Additionally, the computations for the classifier 200 should be reduced, as compared to a classifier using RBFs. Moreover, PCA techniques filter out noise that occurs in an input pattern or patterns. This is beneficial because filtering noise tends to make pattern recognition for images, in particular, easier and can cause increased recognition accuracy.

Classifier 200 comprises the following: (1) an input layer comprising input nodes 110 and unit weights 115; (2) a hidden layer comprising PCA device 220; and (3) an output layer comprising linear weights 225, output nodes 230, a select maximum device 140, and a final output 150.

As with the classifier 100, unit weights 115 are such that each connection from an input node 110 to a BF node 120 essentially remains the same (i.e., each connection is “multiplied” by a one). However, linear weights 225 are such that each connection between a BF node 120 and an output node 130 is multiplied by a weight. The weight is determined and adjusted as described below.

PCA is performed in PCA device 220 by using inputs from input nodes 110. PCA is a well known technique and is widely used in signal processing, statistics, and neural computing. In some application areas, PCA is called the Karhunen-Loeve transform or the Hotelling transform. A reference that uses the PCA technique in face recognition is Turk M. and Pentland A., “Eigen Faces for Recognition,” Journal of Cognitive Neuroscience, 3(1), 71-86 (1991), the disclosure of which is incorporated herein by reference.

The basic goal in PCA is to reduce dimensions from the dimensions of the input data to the dimensions of the output of the PCA. PCA performs this reduction by determining eigenvalues and eigenvectors, which are determined through known techniques. A short introduction to PCA will now be given.

As with the RBF analysis, X=[x₁, x₂, . . . , x_{D}]. The mean of X is μₓ=E{X}, and the covariance of X is as follows:

Cₓ=E{(X−μₓ)(X−μₓ)^{T}}. [3]

From the covariance matrix, Cₓ, one can calculate an orthogonal basis by finding eigenvalues and eigenvectors of the matrix. The eigenvectors, eᵢ, and the corresponding eigenvalues, λᵢ,are solutions of the equation:

Cₓeᵢ=λᵢeᵢ, i=1, . . , n. [4]

The eigenvalues and eigenvectors may be determined through various techniques known to those skilled in the art, such as by finding the solutions to the characteristic equation |Cₓ−λ|=0, where I is the identity matrix and the |•| denotes the determinant of the covariance matrix.

Illustratively, outputs 221, 222 of PCA device 220 are eigenvectors. In this example, there are two eigenvectors 221, 222. Optionally, eigenvalues can also be output with their appropriate eigenvectors. Additionally, eigenvectors can be ordered in the order of descending eigenvalues, with the eigenvectors associated with the largest eigenvalues being ranked higher than eigenvectors associated with smaller eigenvalues. Generally, a predetermined number of eigenvalues will be selected as outputs 221, 222, based on their associated eigenvalues. Optionally, a number of eigenvectors may be selected for outputs 221, 222 by selecting those eigenvectors having associated eigenvectors that are greater than a predetermined value.

Each output node 230 then produces its output through the following equation:

$${z}_{j} = {\sum }_{i} {w}_{ij} {y}_{i} + {w}_{oj} , \qquad [ 5 ]$$

where zⱼ is the output of the jth output node, yᵢ is the activation of one of the outputs 221, 222, wᵢⱼ is the weight connecting the ith output 221, 222 to the jth output node, and wₒⱼ is the bias or threshold of the jth output node. This bias comes from the weights associated with a BF node 120 that has a constant unit output regardless of the input.

The select maximum device 140 and final output 150 operate as in FIG. 1. Thus, the numerous RBF nodes have been replaced with a single PCA device 220, which reduces computational times and steps. Additionally, because the dimensionality from the number of input nodes 110 to the outputs 221, 222 of the PCA device 220 is reduced, there is a reduction in storage requirements, as compared to an RBF classifier.

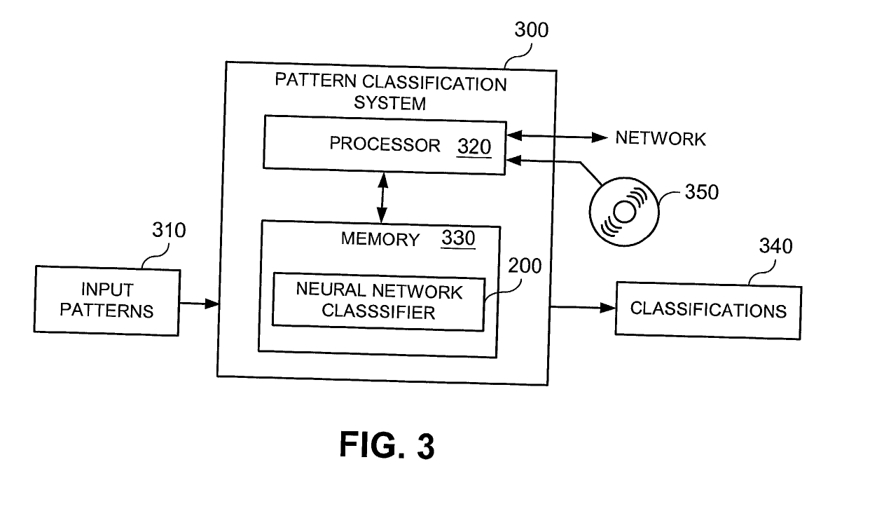

FIG. 3 is an illustrative pattern classification system 300 using the classifier of FIG. 2, in accordance with a preferred embodiment of the invention. FIG. 3 comprises a pattern classification system 300, shown interacting with input patterns 310 and Digital Versatile Disk (DVD) 350, and producing classifications 340.

Pattern classification system 300 comprises a processor 320 and a memory 330, which itself comprises a neural network classifier 200. Pattern classification system 100 accepts input patterns and classifies the patterns. Illustratively, the input patterns could be images from a video, and the classifier 200 can be used to perform face recognition.

The pattern classification system 300 may be embodied as any computing device, such as a personal computer or workstation, containing a processor 320, such as a central processing unit (CPU), and memory 330, such as Random Access Memory (RAM) and Read-only Memory (ROM). In an alternate embodiment, the pattern classification system 300 disclosed herein can be implemented as an application specific integrated circuit (ASIC), for example, as part of a video processing system.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks such as DVD 350, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer readable code means is any mechanism for allowing a computer to read instructions and data, such as magnetic variations on a magnetic media or height variations on the surface of a compact disk, such as DVD 350.

Memory 330 will configure the processor 320 to implement the methods, steps, and functions disclosed herein. The memory 330 could be distributed or local and the processor 320 could be distributed or singular. The memory 330 could be implemented as an electrical, magnetic or optical memory, or any combination of these or other types of storage devices. The term “memory” should be construed broadly enough to encompass any information able to be read from or written to an address in the addressable space accessed by processor 320. With this definition, information on a network is still within memory 350 of the pattern classification system 300 because the processor 320 can retrieve the information from the network.

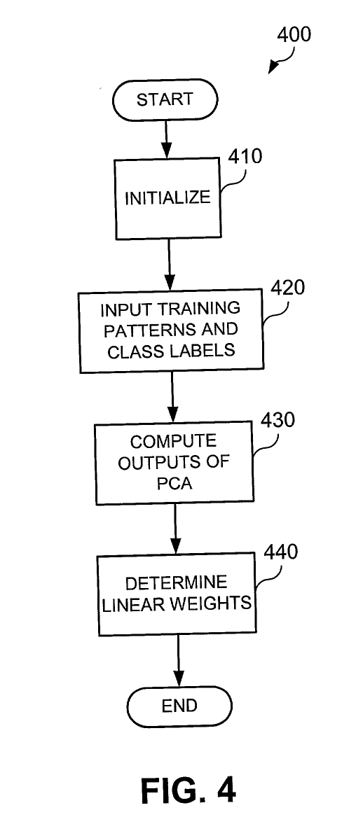

FIG. 4 is a flow chart describing an exemplary method 400 for training the system and classifier of FIG. 3. As is known in the art, training a pattern classification system is generally performed in order to for the classifier to be able to place patterns into classes.

Method 400 begins with the step of initialization 410. In this step, the technique for PCA is chosen, as are other variables, such as the number of initial output nodes and the number of input nodes. Memories can be zeroed or allocated, if desired. Such initialization techniques are well known to those skilled in the art.

In step 420, a number of training patterns and class weights are input to the classifier and system. In step 420, the PCA outputs are determined for each training pattern. After a number of training patterns have been input and PCA outputs have been determined, the linear weights (e.g., linear weights 225 shown in FIG. 2) for each output node are determined. The method 400 then ends.

Method 400 is similar to training methods commonly used in RBF classifiers. This type of training method uses data from a number of input patterns, essentially gathering the data into one large matrix. This large matrix is then used to determine the linear weights. Optionally, it is possible to input one pattern, determine linear weights, then continue this process with additional patterns. Patterns can even be repeated to ensure correct classifications are output. If correct classifications are not output, the weights are again modified.

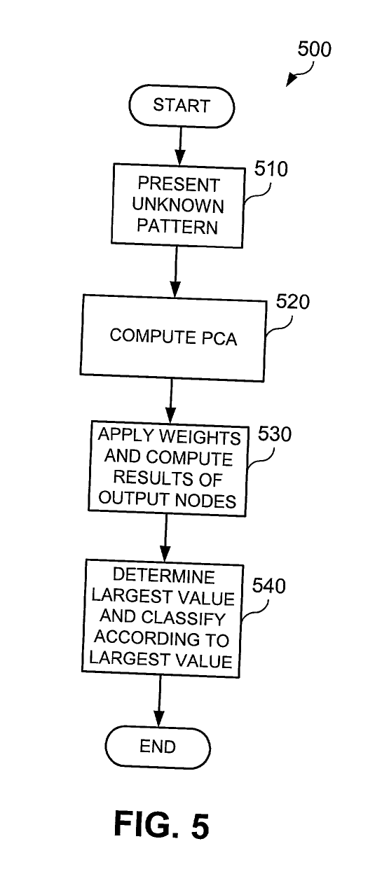

FIG. 5 is a flow chart describing an exemplary method 500 for using the system and classifier of FIG. 3 for pattern recognition and classification. Method 500 is used during normal operation of a classifier, and the method 500 classifies patterns.

Method 500 begins in step 510, when an unknown pattern is presented, through inputs such as input nodes 110 of FIG. 2. A PCA is performed in step 520, and the outputs of the PCA are provided to the connections to the output nodes (step 520). In step 530, the weights are applied to the connections and results of the output nodes are calculated. In step 540, output values from all of the output nodes are compared and the largest output value is selected. The output node to which this value correspond allows a system to determine a class into which the pattern is assigned. The final output is generally simply the class to which the pattern belongs.

Note that method 500 may be modified to include learning steps that can add new classes.

Although forward propagation networks have been discussed herein, the present invention may be used by many different networks. For instance, the present invention is suitable for back propagation networks.

It is to be understood that the embodiments and variations shown and described herein are merely illustrative of the principles of this invention and that various modifications may be implemented by those skilled in the art without departing from the scope and spirit of the invention.

What is claimed is:

1. A method, comprising:
performing Principal Component Analysis (PCA) on a plurality of inputs to produce a plurality of PCA outputs;
coupling each of the plurality of PCA outputs to a plurality of output nodes;
multiplying each coupled PCA output by a weight selected for the coupled PCA output;
calculating a node output for each output node; and
selecting a maximum output from the plurality of node outputs.

2. The method of claim 1, further comprising the step of associating an output class with the maximum output.

3. The method of claim 2, wherein each output node corresponds to a class, and wherein the step of associating a class with the maximum output further comprises determining which output node produces the maximum output and associating the output class with the class corresponding to the output node that produced the highest output.

4. The method of claim 2, further comprising the step of calculating the weights.

5. The method of claim 4, wherein all inputs comprise a single vector that corresponds to a pattern, and wherein the step of determining the weights further comprises the steps of:
inputting at least one training vector;
computing, for each of the at least one training vectors, PCA outputs; and
determining the weights by using the PCA outputs associated with the at least one training vector.

6. The method of claim 5, wherein:
each output node corresponds to a class;
the step of inputting at least one training vector further comprises associating an input class with each training vector; and
the step of determining the weights by using the PCA outputs further comprises determining the weights so that an appropriate output node is selected in the step of selecting a maximum output, the weights being chosen so that input class matches the class corresponding to the appropriate output node.

7. The method of claim 1, wherein each PCA output comprises an eigenvector.

8. The method of claim 7, wherein each eigenvector has a dimension that is less than the number of inputs.

9. The method of claim 7, wherein each output further comprises an eigenvalue corresponding to the eigenvector of the output.

10. A classifier, comprising:
a Principal Component Analysis (PCA) device coupled to a plurality of inputs, the PCA device adapted to perform PCA on the plurality of inputs and to determine a plurality of PCA outputs;
a plurality of connections coupled to the PCA outputs and coupled to a plurality of output nodes, each connection having assigned to it a weight, and each output node adapted to produce a node output by using the PCA outputs and the weights; and
a device coupled to the node outputs and adapted to determine a maximum node output and to associate the maximum node output with a class.

11. A system comprising:
a memory that stores computer readable code; and
a processor operatively coupled to said memory, said processor configured to implement said computer readable code, said computer readable code configured to:
perform Principal Component Analysis (PCA) on a plurality of inputs to produce a plurality of PCA outputs;
couple each of the plurality of PCA outputs to a plurality of output nodes;
multiply each coupled PCA output by a weight selected for the coupled output;
calculate a node output for each output node; and
select a maximum output from the plurality of node outputs.

12. An article of manufacture comprising:
a computer readable medium having computer readable code means embodied thereon, said computer readable program code means comprising:
a step to perform Principal Component Analysis (PCA) on a plurality of inputs to produce a plurality of PCA outputs;
a step to couple each of the plurality of PCA outputs to a plurality of output nodes;
a step to multiply each coupled PCA output by a weight selected for the coupled output;
a step to calculate a node output for each output node; and
a step to select a maximum output from the plurality of node outputs.
